(19) United States
(12) Patent Application Publication
(10) Pub. No.: US 2009/0290944 A1
(43) Pub. Date: Nov. 26, 2009

(54) CARTRIDGE ASSEMBLY FOR CUTTING TOOL

(76) Inventors: Kevin M. Gamble, Stahlstown, PA (US); Thomas J. Long, II, Greensburg, PA (US)

Correspondence Address: KENNAMETAL INC.;Intellectual Property Department, P.O. BOX 231, 1600 TECHNOLOGY WAY, LATROBE, PA, 15650, US

(21) Appl. No.: 12/125,484

(22) Filed: May 22, 2008

(51) Int. Cl. B26D 1/00; B26D 3/00

(52) U.S. Cl. 407/76; 407/9

(57) ABSTRACT

A cutting tool, such as a slotting cutter, includes a support disc rotatable in a predetermined direction on a central axis. The support disc is of a generally cylindrical shape has a plurality of cartridge-receiving pockets. A cartridge assembly is capable of being mounted to the pocket and includes a cutting insert with at least one cutting edge secured to each cartridge assembly. The cartridge assembly includes a tapered, threaded hole for receiving a tapered, threaded screw. The threaded hole is off-center to divide the lower portion of the cartridge assembly into two portions having different thicknesses and flexibility. A slot extends from the threaded hole to a bottom face of the cartridge assembly. The cartridge assembly expands as the tapered, threaded screw is received in the tapered, threaded hole to secure the cartridge assembly in the pocket.

### BACKGROUND OF THE INVENTION

Cutting tools, such as slotting cutters, are known for cutting keyways and the like and, also, for providing a work piece with slots of various width.

Slotting cutters of the nature referred to are somewhat similar to milling cutters in that the cutter usually employs a disc-like member having cutting inserts mounted in the periphery thereof. In a milling cutter, the cutting inserts are generally presented axially, whereas, in a slotting cutter, the cutting inserts protrude radially from the supporting disc and are, thus, presented to the work piece in the radial direction.

In order to form slots rapidly and efficiently, it is essential that the cutting inserts be solidly supported in the support disc and have adequate clearance between the cutting edges of the inserts and the support disc as the material is removed from the work piece. With the inserts solidly supported and having sufficient clearance between the support disc and the cutting edges, the slotting cutter is able to withstand substantial loads and can cut extremely rapidly, freely and accurately while maintaining the ability to easily discharge large volumes of chips that may be generated during the cutting process.

Some slotting cutters include a cartridge assembly that is secured to a cartridge pocket of the support disc. In turn, the cartridge assembly secures multiple opposing inserts that are capable of cutting to a flat bottom and also contour cutting the side and/or the bottom of a slot in a work piece. Because it is important to solidly support the cutting inserts in the support disc, it would be desirable to provide a cartridge assembly that is securely locked into place in the cartridge pocket of the cutter body.

### BRIEF SUMMARY OF THE INVENTION

Briefly, according to this invention, there is provided a cartridge assembly for a cutting tool comprising a rear face, a bottom face, a front face and side faces. A tapered, threaded hole formed through sides faces of the cartridge assembly. The tapered, threaded hole is located off-center with respect to a radially-extending centerline axis to divide the side faces of the cartridge assembly into a front lower portion and a rear lower portion having different thicknesses. A slot is formed through the side faces and extending from the threaded hole to the bottom face. The cartridge assembly expands such that the front face of the cartridge assembly engages the front wall of a pocket of the cutting tool when a tapered, threaded screw is received in the tapered-threaded hole of the cartridge assembly.

In another embodiment, a cutting tool comprises a support disc rotatable in a predetermined direction about a central axis. The support disc is of a generally cylindrical shape and having a plurality of pockets spaced about an outer periphery of the support disc. Each pocket opens radially outwardly and defines a rear wall, a bottom wall and a front wall. A cartridge assembly is capable of being mounted within at least one pocket of the support disc. The cartridge assembly includes a rear face, a bottom face, a front face and side faces. A tapered, threaded hole formed through sides faces of the cartridge assembly. The tapered, threaded hole is located off-center with respect to a radially-extending centerline axis to divide the side faces of the cartridge assembly into a front lower portion and a rear lower portion having different thicknesses. A slot is formed through the side faces and extending from the threaded hole to the bottom face. The cartridge assembly expands such that the front face of the cartridge assembly engages the front wall of a pocket of the cutting tool when a tapered, threaded screw is received in the tapered-threaded hole of the cartridge assembly.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective view of a slotted cartridge assembly mounted to a slotting cutter according to an embodiment of the invention;

FIG. 2 is an exploded view of the slotted cartridge assembly and slotting cutter of FIG. 1;

FIG. 3 is a side elevation view of the slotted cartridge assembly mounted to the slotting cutter; and

FIG. 4 is a cross-sectional view of the slotted cartridge assembly mounted to the slotting cutter taken along line 4-4 of FIG. 3.

### DETAILED DESCRIPTION OF THE INVENTION

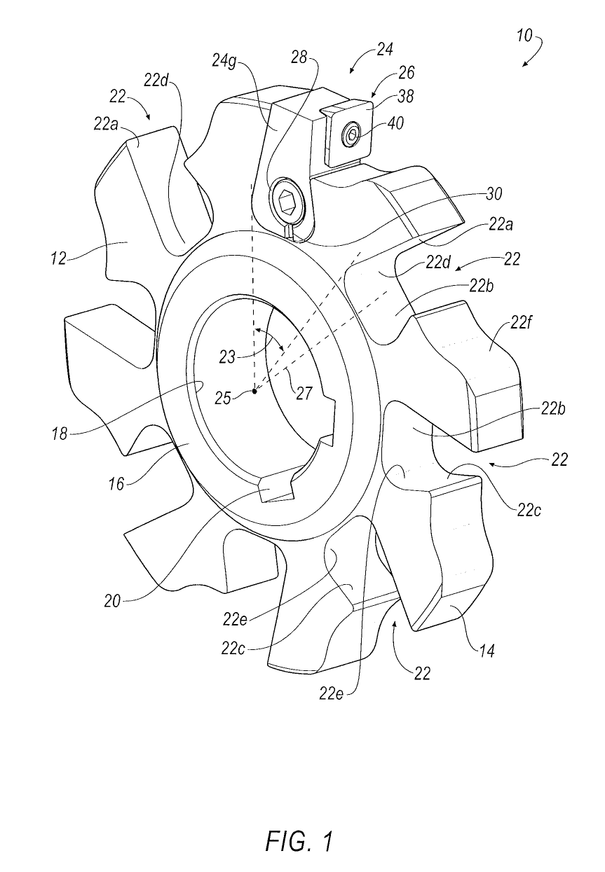

Referring now to FIGS. 1-4, a slotting cutter is shown generally at 10 according to an embodiment of the invention. The slotting cutter 10 includes a support disc 12 having an outer periphery 14 that is capable of being rotatable in a predetermined direction on a central axis perpendicular to the plane of the disc 12. When using the slotting cutter at high speed, a balance screw (not shown) may be used to maintain the rotational balance of the support disc. A central hub region 16 extends through the support disc 12 and is provided with a bore 18 with a keyway 20 for receiving a drive key of a support shaft (not shown). As well known in the art, rotative motion is imparted to the slotting cutter 10 via the drive key which mates with the drive keyway 20.

Provided about the periphery of the support disc 12 are a plurality of cartridge-receiving pockets 22. It will be appreciated that most any suitable number of pockets 22 may be formed in the support disc 12 depending upon the desired material of the work piece to be cut and the diameter of the support disc. In the illustrated embodiment, the slotting cutter 10 includes eight pockets 22 equally spaced about the perimeter of the support disc 12. The pockets 22 are positioned about the circumference of the support disc 12. However, it will be appreciated that the invention can be practiced with any desirable number of pockets 22, depending on the circumference of the support disc 12.

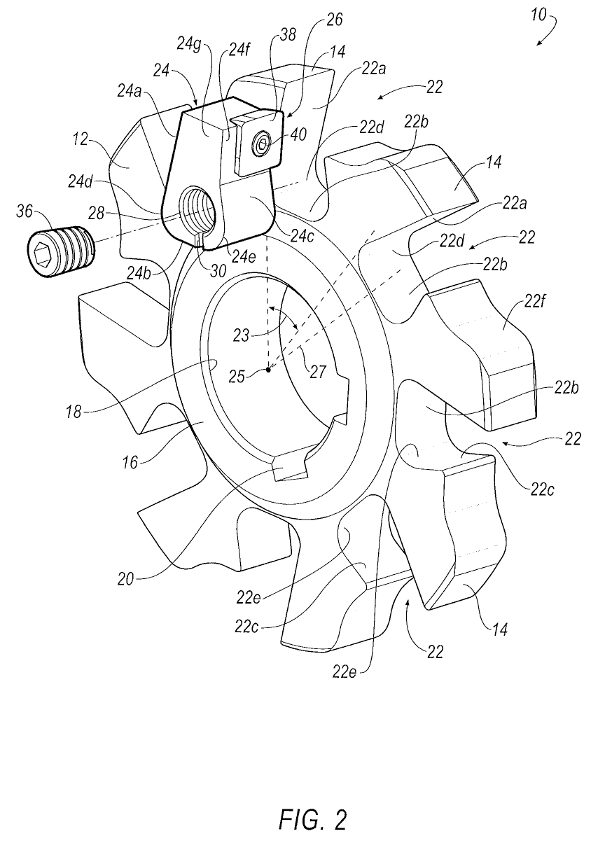

Each pocket 22 opens radially outwardly as defined by a rear wall 22a, a bottom wall 22b and a front wall 22c. The rear wall 22a, the bottom wall 22b and the front wall 22c are substantially planar. A rear radius wall 22d spans between the rear wall 22a and the bottom wall 22b, and a front radius wall 22e spans between the bottom wall 22b and the front wall 22c. As shown in FIGS. 1 and 2, the rear walls 22a of adjacent pockets 22 are positioned about the circumference of the support disc 12 at an angle 23 of approximately 45 degrees with respect to a central axis 25 of the support disc 12, thereby defining the eight total pockets 22 in the support disc 12.

As shown in FIG. 1, the bottom wall 22b of each pocket 22 is substantially perpendicular to a radial line 27 of the support disc 12. The bottom wall 22b extends outwardly from the rear wall 22a toward the front wall 22c and the rear of the next preceding pocket. The front wall 22c is connected to the next preceding pocket through a connecting section 22f that may curve upwardly to the outer periphery 14 of the support disc 12.

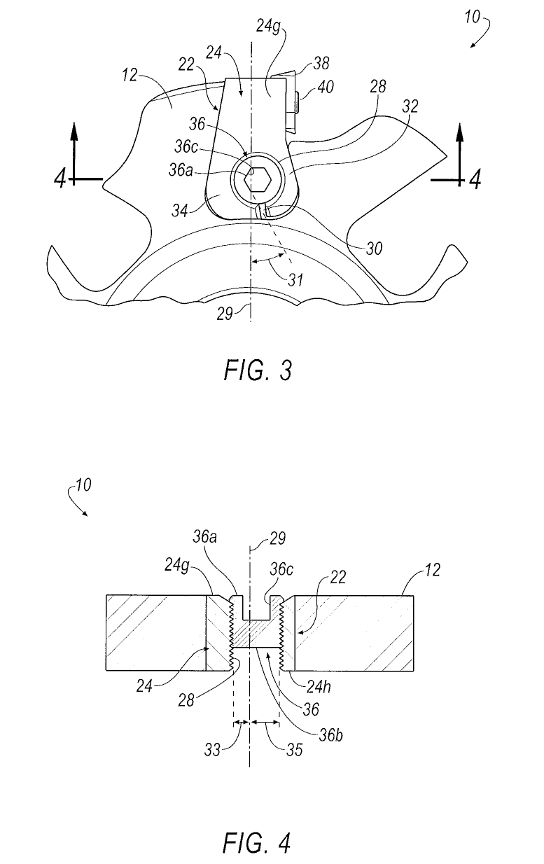

Each pocket 22 is capable of receiving a cartridge assembly 24 secured to the support disc 12. In general, the cartridge assembly 24 is complimentary in shape with the pocket 22. To this end, the cartridge assembly 24 includes a substantially planar rear face 24a, a substantially planar bottom face 24b and a substantially planar front face 24c, similar to the pocket 22. A rear radius face 24d spans between the rear face 24a and the bottom face 24b, and a front radius face 24e spans between the bottom face 24b and the front face 24c. The amount of radius of the rear radius face 24d and the front radius face 24e of the cartridge assembly 24 is slightly larger than the amount of radius of the rear radius wall 22d and the front radius wall 22e of the pocket 22. As a result, a gap exists between the rear radius face 24d and the front radius face 24e of the cartridge assembly 24 and the rear radius wall 22d and the front radius wall 22e of the pocket 22, as shown in FIG. 3. The leading face of the cartridge assembly 24 also include an upper face 24f having an insert-receiving pocket 26 formed therein. As shown in FIG. 4, the cartridge assembly 24 also includes a pair of side faces 24g, 24h (only side face 24g is visible in FIGS. 1-3).

One aspect of the invention is that the cartridge assembly 24 includes a tapered, threaded hole 28 formed through the side faces 24g, 24h. The hole 28 is tapered such that the diameter of the threaded hole 28 is larger at the side face 24g and smaller at the side face 24h, as shown in FIG. 4. A slot 30 is formed through the side faces 24g, 24h and extends from the threaded hole 28 to the bottom face 24b of the cartridge assembly 24. The slot 30 may be formed at an angle 31 with respect to a central, radially-extending axis 29 of the cartridge assembly 24, as shown in FIG. 3. The tapered, threaded hole 28 is located off-center with respect to the radially-extending centerline axis 29 to divide the side faces 24g, 24h of the cartridge assembly 24 into a front lower portion 32 and a rear lower portion 34 having different thicknesses. Specifically, the thickness of the front lower portion 32 of the side faces 24g, 24h from the front face 24c to the threaded hole 28 is less than the thickness of the rear lower portion 34 of the side faces 24g, 24h from the rear face 24a to the threaded hole 28. As a result, the front lower portion 32 of the cartridge assembly 24 is relatively more flexible as compared to the rear lower portion 34 of the cartridge assembly 24.

A tapered, threaded screw 36 is capable of being received in the threaded hole 28 of the cartridge assembly 24. Similar to the tapered, threaded hole 28 in the cartridge assembly 24, the threaded screw 36 has a relatively larger diameter at an end 36a and a smaller diameter at an opposite end 36b. The threaded screw 36 may include a tool access 36c at one end 36a, 36b for allowing a tool (not shown), such as an Allen® wrench, and the like, to be inserted into the tool access 36c for rotating the threaded screw 36.

As shown in FIG. 4, the rear lower portion 34 formed by the threaded hole 28 has a greater taper angle 33 with respect to the radially-extending centerline axis 29 than a taper angle 35 of the front lower portion 32 formed by the threaded hole 28. This feature causes the front lower portion 32 to move a greater distance than the rear lower portion 34 when the threaded screw 36 is received in the threaded hole 28. In an alternate embodiment, the taper angle 33 is approximately equal to the taper angle 35.

The insert-receiving pocket 26 of each cartridge assembly 24 is capable of having an indexable cutting insert 38 mounted therein. The cutting insert 38 may be of a type well known in the art and may be formed of a hard wear resistant material, such as cemented carbide, and the like. As well known in the art, the insert 38 can be mounted to the pocket 26 using a threaded fastener 40, such as a mounting screw, and the like. The cutting insert 38 has at least one cutting edge that can be selectively presented to a workpiece (not shown) by loosening the cutting insert 38 and indexing the insert 38 about an axial axis, and then again mounting the insert 38 in the pocket 26.

The cartridge assembly 24 is secured to the pocket 22 by rotating the tapered, threaded screw 36 within the tapered, threaded hole 28 of the cartridge assembly 24. As the tapered, threaded screw 36 is received in the tapered, threaded hole 28, the lower portions 32, 34 expand outwardly with respect to the radially-extending centerline axis 29 of the cartridge assembly 24. Because the front lower portion 32 is less thick than the rear lower portion 34 (and is relatively more flexible), the front lower portion 32 moves outwardly at a greater distance as compared to the rear lower portion 34. As a result, the front lower portion 32 moves upward and outwardly a greater distance as compared to the rear lower portion 34, and the substantially planar front face 24c of the cartridge assembly 24 engages the substantially planar front wall 22c of the pocket 22. As the tapered, threaded screw 36 is continued to be rotated, the substantially planar rear and bottom faces 24a, 24b of the cartridge assembly 24 engage the substantially planar rear and bottom walls 22a, 22b of the pocket. In this manner, the cartridge assembly 24 is secured to the pocket 22 of the support disc 12 using three-point contact.

As described above, the off-centered tapered, threaded hole 28, the tapered, threaded screw 36 and the slot 30 of the cartridge assembly 24 allows the cartridge assembly 24 to be easily secured to the pocket 22 of the support disc 12. The cartridge assembly 24 is secured in the pocket 22 using three contact points between the substantially planar rear wall 22a, the substantially planar bottom wall 22b and the substantially planar front wall 22c of the pocket 22, and the substantially planar rear surface 24a, the substantially planar bottom surface 24b, and the substantially planar front surface 24d of the cartridge assembly 24, respectively.

It will be appreciated that the principles of the invention can be applied to a cutting tool other than a slotting cutter that requires a cartridge assembly to be secured to a pocket of the cutter body. For example, the principles of the invention can be applied to a milling cutter, and the like.

The documents, patents and patent applications referred to herein are hereby incorporated by reference.

While the invention has been specifically described in connection with certain specific embodiments thereof, it is to be understood that this is by way of illustration and not of limitation, and the scope of the appended claims should be construed as broadly as the prior art will permit.

What is claimed is:

1. A cartridge assembly for a cutting tool, comprising:
a rear face, a bottom face, a front face and side faces;
a tapered, threaded hole formed through the side faces of the cartridge assembly, the tapered, threaded hole located off-center with respect to a radially-extending centerline axis to divide the side faces of the cartridge assembly into a front lower portion and a rear lower portion having different thicknesses; and
a slot formed through the side faces and extending from the threaded hole to the bottom face,
wherein the cartridge assembly expands such that the front face of the cartridge assembly engages a front wall of a cartridge-receiving pocket of the cutting tool when a tapered, threaded screw is received in the tapered-threaded hole of the cartridge assembly.

2. A cartridge assembly according to claim 1, wherein the slot is formed at an angle with respect to the radially-extending centerline axis of the cartridge assembly.

3. A cartridge assembly according to claim 1, wherein the rear face, the bottom face and the front face of the cartridge assembly are substantially planar.

4. A cartridge assembly according to claim 1, wherein the cartridge assembly further includes a rear radius face spanning between the rear face and the bottom face, and a front radius face spanning between the bottom face and the front face.

5. A cartridge assembly according to claim 4, wherein a radius of the rear radius face and the front radius face of the cartridge assembly is greater than a radius of a rear radius wall and a front radius wall of the cartridge-receiving pocket.

6. A cartridge assembly according to claim 1, wherein the rear lower portion has a taper angle that is greater than a taper angle of the front lower portion of the cartridge assembly.

7. A cartridge assembly according to claim 1, wherein the cartridge assembly further includes an insert-receiving pocket for mounting a cutting insert therein.

8. A cartridge assembly according to claim 7, wherein the cutting insert is indexable.

9. A cutting tool, comprising:
a support disc rotatable in a predetermined direction about a central axis, the support disc being of a generally cylindrical shape and having a plurality of cartridge-receiving pockets spaced about an outer periphery of the support disc, each pocket opening radially outwardly and defined by a rear wall, a bottom wall and a front wall; and
a cartridge assembly capable of being mounted within at least one cartridge-receiving pocket of the support disc, the cartridge assembly including a rear face, a bottom face, a front face and side faces, the cartridge assembly further including a tapered, threaded hole formed through the side faces of the cartridge assembly, the tapered, threaded hole located off-center with respect to a radially-extending centerline axis to divide the side faces of the cartridge assembly into a front lower portion and a rear lower portion having different thicknesses, the cartridge assembly further including a slot formed through the side faces and extending from the threaded hole to the bottom face,
wherein the cartridge assembly expands such that the front face of the cartridge assembly engages the front wall of the pocket when a tapered, threaded screw is received in the tapered-threaded hole of the cartridge assembly.

10. A cutting tool according to claim 9, wherein the slot is formed at an angle with respect to the radially-extending centerline axis of the cartridge assembly.

11. A cutting tool according to claim 9, wherein the rear wall, the bottom wall and the front wall of the cartridge-receiving pocket are substantially planar, and wherein the rear face, the bottom face and the front face of the cartridge assembly are substantially planar.

12. A cutting tool according to claim 9, wherein the cartridge-receiving pocket further includes a rear radius wall spanning between the rear wall and the bottom wall, and a front radius wall spanning between the bottom wall and the front wall, and wherein the cartridge assembly further includes a rear radius face spanning between the rear face and the bottom face, and a front radius face spanning between the bottom face and the front face.

13. A cutting tool according to claim 12, wherein a radius of the rear radius face and the front radius face of the cartridge assembly is greater than a radius of the rear radius wall and the front radius wall of the cartridge-receiving pocket.

14. A cutting tool according to claim 9, wherein the rear lower portion has a taper angle that is greater than a taper angle of the front lower portion of the cartridge assembly.

15. A cutting tool according to claim 9, wherein the cartridge assembly further includes an insert-receiving pocket for mounting a cutting insert therein.

16. A cutting tool according to claim 15, wherein the cutting insert is indexable.
